(19) United States
(12) Patent Application Publication
(10) Pub. No.: US 2022/0215351 A1
(43) Pub. Date: Jul. 7, 2022

(54) AUTOMATIC SCHEDULING OF ACTIONABLE EMAILS

(71) Applicant: VMware, Inc., Palo Alto, CA (US)

(72) Inventors: Adam Chow, Atlanta, GA (US); Ravish Chawla, Atlanta, GA (US)

(21) Appl. No.: 17/142,119

(22) Filed: Jan. 5, 2021

(51) Int. Cl. G06Q 10/10; G06N 20/00

(52) U.S. Cl. CPC G06Q 10/1097; G06N 20/00; G06Q 10/107

(57) ABSTRACT

Examples described herein include systems and methods for scheduling tasks based on emails intended for a user. An email application, agent, or server can identify a task by parsing an unread email intended for a user. Then a machine learning model specific to that user can be applied to the task and task list information including at least one open time slot. The machine learning model can be previously trained based on timing of prior tasks performed by the user. Based on an output from the model, the task can be scheduled at a first time within the time slot and displayed in a task list on a user device. When the user completes the task, the machine learning model can be updated based on a second time in which the task is completed relative to the first time.

### BACKGROUND

The landscape of working remotely has changed with new mobile solutions and trends within the corporate environment. Increasingly, employees use mobile devices to perform some amount of work from home or in the field at varying hours. However, employees now face a problem of needing to be reachable at any time. Constant interruptions make it difficult for employees to complete tasks that require periods of concentration. Additionally, employees may have a difficult time disconnecting long enough to maintain mental health, which ultimately would boost productivity. Workers also lose track of their task lists and often mistakenly deprioritize certain tasks in favor of interrupting factors that arise in a typical workday.

Managers want to ensure workers are productive, but current systems provide little mitigation against interrupting factors and generally rely on the worker to create their own work schedule. The problem is difficult to solve because different users may have different schedules or habits. Workers can live in different time zones and have differing family commitments that make ubiquitous schedules impossible in terms of maximizing user productivity. Additionally, there are times when a worker is remote with only a mobile device, struggling to focus on what comes into their inbox. The remote worker often will forget to address email-related tasks between scheduled appointments. There simply is no solution that adequately addresses these interrelated issues.

As a result, a need exists for systems that assist a user with maintaining an optimal schedule for email-related tasks. Instead of asking workers to be productive all the time, a need exists to adjust working schedules to accommodate workers' lives and provide them with new email-related tasks when they are not already consumed by a period of productivity.

### SUMMARY

Examples described herein include systems and methods for scheduling actionable emails. An example method can include a task scheduling service that executes on a server-side or client-side. For example, the task scheduling service can be a process that executes on a secure email gateway (“SEG”), email server, or the user device of the email recipient, in different examples.

The task scheduling service can automatically schedule new tasks such as email responses and other actions for times when the user is most likely to be responsive and not involved in some other task. In one example, the service identifies a task by parsing an unread email intended for a user. The parsing can include looking for material associated with backend task systems, such as JIRA, GIT, CONCUR, and others. The parsing can also look for emails that include users, documents, and keywords that would indicate a response task is needed. When a task is recognized, the task scheduling service can then attempt to schedule the task in a task list for a time that the user is likely to be able to work on the task.

To do this, the task scheduling service can locate an open time slot in a calendar associated with the user. Locating the open time slot can involve communicating with a calendar application on the user device or with a backend database that tracks calendar entries, such as to-do items. The task scheduling service can then choose a time within the available time slots based on outputs from a machine learning (“ML”) model. The ML model can be pre-trained using deep reinforcement learning, which also allows for continuous modification of an ML model to coincide with a user's evolving habits.

In one example, the service retrieves an ML model that is pre-trained and specific to the user. The training can be continuous such that the ML model stay up to date regarding the types of tasks the user tends to perform at different time periods throughout particular days. The training can include timing information regarding performance of prior tasks by that user. The ML model can then predict which types of tasks the user is likely to perform at various points of different days of the week.

The task recognized by the service can then be used as an input to the retrieved ML model, along with the available time slots. The ML model can then output a time within the available timeslots that the user is most likely to perform the task. The service can then schedule the task within the time slot based on the result from the machine learning model. To schedule the task, the service can make an application programming interface (“API”) call to the calendar application or backend database, in an example. This can cause the task to show up on the user device within a calendar or to-do list that displays on the user device. A notification can also display on the user device as the time draws near for performing the task.

The service can then monitor whether the user performed the task and when the performance occurred. This can include receiving a confirmation from the user device in an example. For example, an agent executing on the user device can monitor user interactions with the task in an example and notify a management server when the task has been performed. Alternatively, the service can query a backend server associated with the task to see when the task was completed. The task completion information, including the timing, can be used to update the ML model. This can allow for a continuous machine learning that adjusts future task reminders to the realities of the user's schedule.

The email scheduling service can use outputs from the ML model to move tasks around within a calendar based on optimal performance times for that user and to ensure a healthy workload for the user. This can include scheduling breaks for the user to do miscellaneous things or go outside, such that the user does not become overwhelmed or burned out as easily. If a new task is more likely than an existing task to be performed by the user at a first time, the scheduling service can move the second task to another time. The scheduling service can also prompt the user to accept the change, in an example.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is an illustration of an example system for scheduling actionable emails.

FIG. 2 is a flowchart of an example method for scheduling actionable emails.

FIG. 3 is another flowchart of an example method for scheduling actionable emails.

FIG. 4 is a sequence diagram of an example method for scheduling actionable emails.

FIG. 5 is an illustration of an example graphical user interface (“GUI”) of a user device used to display scheduled actionable emails.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Examples described herein include systems and methods for scheduling tasks based on emails. The tasks can be presented in a task list, such as a calendar or separate list of to-do items. The tasks can include actions, such as returning an email, submitting an expense report, or even taking a break. The task scheduling service can operate on a server, such as a management server that has access to emails intended for a user. The management server can be part of a unified endpoint management (“UEM”) system, and the user can be enrolled in the UEM system. The management server can access an ML model that is trained according to actions of the user. The ML model can predict when the user is most likely to perform the task without disrupting existing workflow, such as by outputting likely times for the task completion. The task can then be added to the user's task list, which can display on the user device. The management server can then monitor whether the prediction is correct based on whether the user performs the task during the predicted time slot. This monitoring can be performed by querying a backend server associated with the task or by receiving task completion information from an agent that can execute on the user device. This feedback can be used for deep reinforcement learning (“RL”) to continuously train and update the user's ML model.

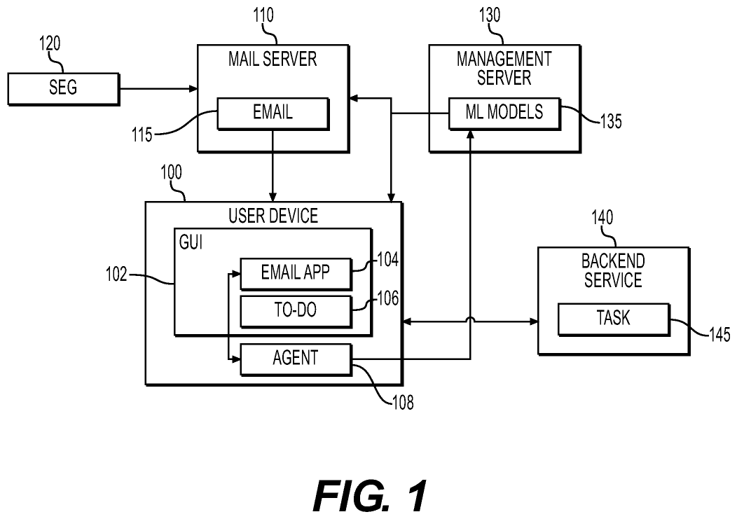

FIG. 1 provides an illustration of a system for scheduling tasks based on email. The system can include a user device 100, which can be any type of computing device. Common examples of a user device 100 include laptop and desktop computers, phones, smartphones, and tablets. The user device 100 can include a processor, which can be a hardware processor such as a single- or multi-core central processing unit (“CPU”). The processor can execute instructions stored in a non-transitory, computer-readable storage medium. For example, the instructions can be stored in a memory storage location of the user device 100.

The user device 100 can include various applications such as applications provided by default with the operating system of the user device 100, applications downloaded from an application store, applications provisioned by a server or other component of a management system, and web-based applications. In this example, the user device 100 includes an email application 104 to be discussed further, below.

The system can also include a management server 130. The management server 130 can be a single server or a group of servers having at least one hardware-based processor. The management server 130 can include a storage location accessible to the server, either locally or remotely. The management server 130 can provide various management functions for a user device 100. For example, the management server 130 can handle an enrollment procedure that enrolls a user device 100 into the overall management system (e.g., the UEM system). An enrollment procedure can be instigated by contacting the management server 130 at a specific URL that triggers enrollment. The management server 130 can also provision applications and profiles to the user device 100. The profiles can be used to remotely control certain functionality of the user device 100, such as access to enterprise resources.

The management server 130 can store different ML models 135 that correspond to the different users enrolled in the UEM system. In one example, the ML models 135 are trained based on machine learning algorithms that execute on the management server 130 or on another server, such as in the cloud. The training can be provided by an ML platform provided by a third party, in an example. The service that trains the ML models 135 can then provide current versions of the ML models 135 to the management server 130 or, in another example, directly to a user device 100. The management server 130 can also receive feedback regarding an ML model 135 and use that feedback to adapt the model over time. In an example where the management server 130 does not train the models, the management server can provide a dataset for use in training, provide inputs to run through a trained model, or provide feedback to further adapt a trained model.

The user device 100 can include a management agent 108 that allows the management server 130 to exercise some measure of control over the user device 100. The agent 108 can be installed by the management server 130 as part of an enrollment process that enrolls the user device 100 with the management system. The agent 108 can be a standalone application, or it can be wrapped into another application, such as a portal application that provides access to various enterprise applications. The agent 108 need not operate on the application layer, however, and can instead be implemented at the operating-system level in some examples.

The agent 108 can be responsible for generating a task list 106 in one example. For example, when the management server 130 executes a task scheduling service that utilizes an ML model 135, the management server 130 can add a task by communicating the task to the agent 108 at the user device 100. The agent 108 can then add the task to the appropriate task list 106, which can be the user's calendar or some other to-do list.

The user device 100 can also include an email client 104, which can be any type of email application. Although the functionality described herein relates to an email client 104, the same disclosure can apply to any type of application capable of operating on text documents. Examples include messaging applications such as SLACK and word-processing applications such as WORD. References to the email client 104 or to an “email” are not intended to be limiting, and instead are intended to capture any type of application that can operate on text-based messages or documents. The email client 104 can include calendar functionality or provide a task list 106. Alternatively, a separate task list 106 can be maintained on the user device 100, such as by agent 108. The task list 106 can be populated both by user input and automatically by the task scheduling process discussed herein. A GUI 102 can display the task list 106 on the user device 100.

The email client 104 can send and receive emails 115 by utilizing an email server 110. The email server 110 can be a remote server that stores information about a user's email account, such as the emails 115 currently in the user's inbox, and provides that information to the user device 100. The email server 110 can also send outgoing emails on behalf of the user device 100, to be received by a separate server or device on the other end of the communication chain. In some examples, a secure email gateway (“SEG”) 120 can route email 115 to the email server 110. The SEG 120 can be either incorporated into the email server 110 or provided as a standalone gateway server. The SEG 120 can communicate with the management server 130 and implement rules for allowing or disallowing access to the email server 110. In one example, the SEG 120 can route email 115 to the mail server 110, but also send a copy of the email 115 to the management server 130 for task scheduling purposes.

The task scheduling process can execute as a client-side or server-side process. For example, the management server 130 can execute the scheduling process on emails that are intended for the user. However, this functionality can alternatively be incorporated at any device that has access to the user's emails. For example, the task scheduling process can instead run on the mail server 110 or SEG 120. In some examples, the task scheduling process can run at the user device 100. Therefore, the steps described herein for task scheduling at the management server 130 can also apply to these other devices. For example, an ML model 135 can be converted into a device-ready executable file, allowing the device 100 to process text using only the ML model 135 residing on the device 100.

In one example, after receiving an email 115, management server 130 can then parse the email to determine if the email 115 indicates one or more tasks. The parsing can include looking for keywords that indicate a response is desired. The parsing can also look for links and keywords that indicate an actionable task 145 at a backend service 140. For example, the enterprise can employ task-related services such as JIRA, SALES FORCE, or any number of applications or services that an enterprise uses as part of its workflow. The email 115 can reference a project or lead that should be updated in one of those backend services 140. The backend service 140 can execute in the cloud, on the management server 130, or on some other server.

If the management server 130 (or other device) recognizes a task in the email 115, the management server 130 can use task information gleaned from the email 115 as inputs to an ML model 135. The ML model 135 can be identified per the recipient user of the email 115. In one example, each user in the UEM system can have its own ML model 135 that is maintained and continuously trained. Inputs to the ML model can include task type, backend service, senders, copied recipients, urgency rating, and task list information (e.g., open time slots). Example task types include an email reply, issue or bug tracking, time entry, project update, and document revision. An input identifying a backend service can identify the backend service 140 broadly, such as JIRA or SALES FORCE, or more specifically, such as an actual item or issue tracking number utilized by the backend system 140. As mentioned, the ML model 135 can also receive information about open time slots in a user's task list 106. Either the agent 108 or management server 130 can locate open time slots in the user's task list 106. In some cases, one or more days from the user's task list 106 can be provided as input to the ML model 135. Alternatively, the ML model 135 can be provided with an address to a user's current task list 106, granting the ML model 135 access. The urgency input can be based on an importance flag in the email or based on the user's relation to the sender, such as the sender being a client or the user's boss.

The ML model 135 can also prioritize task scheduling based on the perceived importance of the task. For example, when an email or a task is assigned to the user by the user's direct supervisor or manager, the ML model 135 can recognize the relationship and schedule the task in a time slot where the user is normally available and productive. Priority relationships can be recognized based on an organizational hierarchy, which can be stored in a database or as a graph or tree, in an example. Alternatively, the ML model 135 can determine priority relationships based on the frequency of emails and responses. For example, if a user always responds to emails from another user, the relationship can be prioritized over that with a sender to which the user does not respond as often. This can help the ML model 135 prioritize the scheduling of competing tasks based on which of the senders is perceived to be more important with respect to the user.

Likewise, the ML model 135 can utilize copied recipients in determining a task's importance for prioritization purposes. If an email includes the user's manager as a copied recipient, this can cause the ML model 135 to prioritize a task contained in the email over others when scheduling email or task responses. For example, other emails that do not include the manager can be prioritized lower and scheduled at less productive time slots.

In one example, one or more ML models can also be used for parsing the email itself and for generating the inputs to the user's ML model 135. For example, the parsing ML models can use natural language understanding (“NLU”). NLU describes a process where machine learning is used to classify intents and extract entities from slots. For instance, given a natural language phrase like “What is the weather in Atlanta?” the NLU process should determine the intent as a “weather query” and the location slot as “Atlanta.” The ML models 135 can also utilize “embeddings,” which can be used to map words into numerical vectors and cluster vectors having similar meanings or semantics. For example, the embedding vector of the word “king” should be very close to the vector of the word “emperor.” Natural language utterances can be used as inputs to the embedding layer. Pre-trained embeddings can allow a ML model 135 to learn meaningful relationships between words and labels, even on a sparse dataset.

In one example, the ML model 135 can receive “intents” and “slots” as inputs as part of determining which tasks to schedule. This can be a more dynamic and intelligent approach than merely looking for keywords. In this example, the task scheduling service can parse the email 115 to determine any relevant “intents” and associated “slots.” An intent can be any type of action, such as changing a password, deleting an account, and requesting a recommendation. The identified slots can provide further context to the intent, such as an account name, type of software, time, or a location. In some examples, the task scheduling process can also apply tags, or labels, to the words within an intent. An intent can be a chunk of multiple words, so each word can be labeled accordingly. In some examples, the Inside-Out-Beginning (“IOB”) format can be used. In this format, each word in an intent is labeled with an O-tag, B-tag, or I-tag, based on where the words appear. For example, the first word in an intent can be labeled with a B-tag, the following word can be labeled with an I-tag, and words that are not part of a slot can be given an O-tag. IOB tags can distinguish different types of words from each other, allowing the ML model 135 to learn semantic relationships between them and the words that relate to their context.

The ML model 135 can use a combination of these inputs to generate an output. The output can indicate a time for scheduling a task. The task can be an instruction for the user to respond to an email, update a backend service 140, or make changes to work product. The time selected by the ML model 135 can be within one of the open time slots of the current task list 106. In some instances, the ML model 135 output can also indicate a second time for an existing task that should be moved to accommodate the newly scheduled task.

If there is not yet enough data available for the user to build an ML model 135 or for the ML model 135 to predict when to schedule the task, the scheduling service can make a random task assignment within an open slot. For example, if an expense report email arrives, the task scheduling process can schedule a task to create the expense report and schedule the task randomly. The random scheduling can result in an initial batch of data that can be used to train an ML model 135 for that user. For example, the training may require information relating to when the user performed fifty different tasks as part of an initial training of a model that will predict times during which the user is likely to perform similar future tasks.

In one example, the management server 130 can also track whether the user performs the task in relative proximity the scheduled first time. This can allow for using RL algorithms to update the user's ML model 135. If the task is completed during the scheduled time slot or within a relative threshold period from the first time, the ML model can get a positive reward. If not, the output can be disincentivized. This can allow the ML model 135 to increase in accuracy over time when the training algorithm is set to accumulate as many positive rewards as possible.

To track whether the task was performed, the management server 130 can receive performance information from the agent 108 in one example. For example, the agent 108 can track whether an email was replied to or whether the user performed a task in another application. These applications can include application programming interface (“API”) access that allows the agent to query regarding specific tasks performed within the applications or backend services 140. The agent 108 can then report the task timing to the management server 130. Alternatively, the management server 130 itself can query the email application 104, email server 110, or backend service 140 to determine if the user completed the task at a time proximate to when the task was scheduled. The management server 130 can then use the actual timing of the task completion as a reward (when proximate to the scheduled time) or a disincentive (when not proximate) in continued training of the ML model 135.

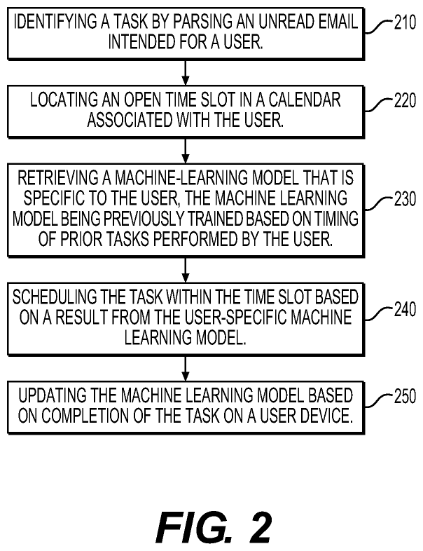

FIG. 2 provides a flowchart of an example method for scheduling tasks based on emails. The task scheduling process can execute at any of the management server 130, SEG 120, email server 110, or user device 100, in different examples. At stage 210, the task scheduling process can identify a task by parsing an unread email. The unread email can be routed to the server where the task scheduling process executes.

In one example, the task scheduling process can use a detection ML model 135 to discover an “intent” with the email. The intent can relate to the email 115 itself or any backend service 140 available to the user. For example, the ML model 135 can determine that an incoming email includes an intent relating to authorizing an expense. The determination that the text portion of the email includes an intent, such as authorization, can constitute a trigger at stage 210. The trigger can also include the “slot” related to the intent. For example, if the intent is authorization, the slot can be an expense report. The trigger can cause additional categorization by the ML model 135, such as whether to schedule the task and at what time.

At stage 220, the task scheduling process can locate an open time slot in a task list 106 associated with the user. This can include openings in a calendar, in an example. The openings can be determined by, for example, the agent 108 that can access the user's calendar on the user device 100, in an example. Alternatively, the management server 130 can access the calendar and determine the time slots. In still another example, the user's ML model 135 can determine the open time slots based on access to the user's calendar or other task list. For example, the open time slots or some portion of the task list 106 containing them can be provided as an input to the ML model 135. For example, a relevant portion the task list 106 (e.g., the next two days in the calendar) can be provided as an input to the ML model 135, which performs the task of locating the open time slots itself. Access to the calendar can be achieved based on API calls and providing the user's credentials, in an example. An open time slot can be any time period where a high priority task is not already scheduled. In one example, lower priority tasks can be treated as a tier two open time slot, such that the ML model 135 can favor truly open time slots but still consider placement of a task in a tier two time slot when warranted based on the user's past task completion behavior.

At stage 230, the task scheduling process can retrieve and apply an ML model 135 corresponding to the user. In one example, the ML model 135 can be used to determine whether the identified task warrants scheduling and, if so, at what time. The ML model 135 can be pre-trained based on which tasks the user typically handles during a workday. The management server 130 can keep track of the most recent iteration of the user's ML model 135, which can be continuously updated based on the actual times at which the user performs various tasks.

To apply the ML model 135, the task scheduling process can supply the task and open time slots as inputs in an example. Based on those inputs, the ML model 135 can output a suggested time for scheduling the task. The suggested time should reflect a time when the user is not working on something else and has historically been shown to be active in responding to that task type.

At stage 240, the task scheduling process can then take steps to schedule the task at a first time based on the ML model 135 output. For example, the task can be included in a task list 106 as a reminder for the user, such as a reminder to authorize an expense. To do this, the management server 130 can send a task scheduling request to the agent 108, which in turn can place the task in a task list 106 on the user device 100. Alternatively, the management server 130 can schedule the task on the server side where task list entries (e.g., calendar entries) are kept, such as by making an API call to the appropriate calendar server.

In one example, scheduling the task at the first time can include moving a second task that is already scheduled at that time. For example, the second task can be an input at the ML model 135 also, such as when a portion of the task list is provided as an input. The ML model 135 can predict that the user is more likely to act on the second task at some other time, or that the user is at least more likely to act on the first task than the second task at the first time. In such a case, the task scheduling process can move the second task to another time and schedule the first task at the first time. Doing so can involve rearranging the tasks at the management server 130, making API calls to a separate task list server, or communicating with the agent 108 on the user device 100 to rearrange tasks, locally at the user device 100.

The task itself can include information that helps the user accomplish the task. For example, the management server 130 can retrieve task-related information based on the intent-slot pairing discovered in stage 210. For example, the management server 130 can create an object, such as a JSON or XML file, that includes the intent and slot detected by the ML model 135. Using the object, the management server 130 can identify a relevant backend service 140, and then use an appropriate API call to access the backend server 140. The management server 130 can also authenticate the user's identity as part of accessing the backend service 140 on the user's behalf. This can allow the management server 130 to retrieve context for the task, such as any due dates, issue numbers, or last modification times. The management server 130 can also gather useful user information that may be needed to complete the task, such that the task itself might be easier for the user to perform.

The management server 130 can provide the task to the user device 100 or calendar server as part of stage 240, causing the device 100 to display the task. This can be done on a GUI 102, and can be based on the intent-slot pairing and the additional information provided by the management server 130. The GUI 102 can include actionable buttons that a user can select to perform an action related to the task. For example, if the intent was authorization and the slot was a particular expenditure, the GUI 102 can provide information about the expenditure as well as actionable elements for authorizing or declining the expenditure. The user's input can then be relayed back to the management server 130, which in turn can utilize an API call to access the relevant backend server 140 and make any change indicated by the user's input.

The GUI 102 of the user device 100 can display the task list 106 with different color coding for different task types. For example, a blue task can be something that exists on the user's calendar. A green task can be a generated email reminder. An orange task can be a personal task that the user added to the task list, and a yellow task can be wellness related. In this example, the task scheduling process can schedule the green tasks, such as email reminders and reminders regarding other work tasks. In one example, the task scheduling process can also suggest wellness relate tasks, such as going outdoors or taking a break, based on analysis of the user's packed task list and history of time periods when the user stops responding to tasks. The ML model 135 can even consider which managed applications the user uses, and when. For example, the agent 108 can report when the user is actively working in an application on the user device 100. If the user is not being productive, scheduling a break could help.

At stage 250, the management server 130 can update the ML model 135 based on a second time in which the user completes the task. The ML model 135 can be trained at the management server 130 or elsewhere, such as at a training platform that executes in the cloud, in order to update the ML model 135.

The training can be based on the second time relative to the first (scheduled) time. This time difference can either result in a reward or disincentive, such that the ML model 135 will tend to schedule similar tasks at similar or different times. Said another way, the timing of the task completion itself can determine whether the task is treated with a positive or negative incentive. If the task is completed at a time proximate to the schedule, such as within 30 minutes of the scheduled time or open slot where the task was scheduled, then a positive incentive can be applied. Otherwise, a negative incentive can be applied. The training algorithm can be programmed to seek the highest level of reward. Therefore, a positive incentive can reinforce placing similar tasks at a similar time whereas a negative incentive can cause the retrained ML model 135 to try a different time for similar tasks in the future. In one example, the time difference between the second time (task completion) and the first time (scheduled task) can correlate to how many points are supplied as a reward or disincentive. For example, if the time difference is 15 minutes, a 50-point reward can be applied. But if the time difference is two hours, a 100-point disincentive (i.e., negative 100) can be applied.

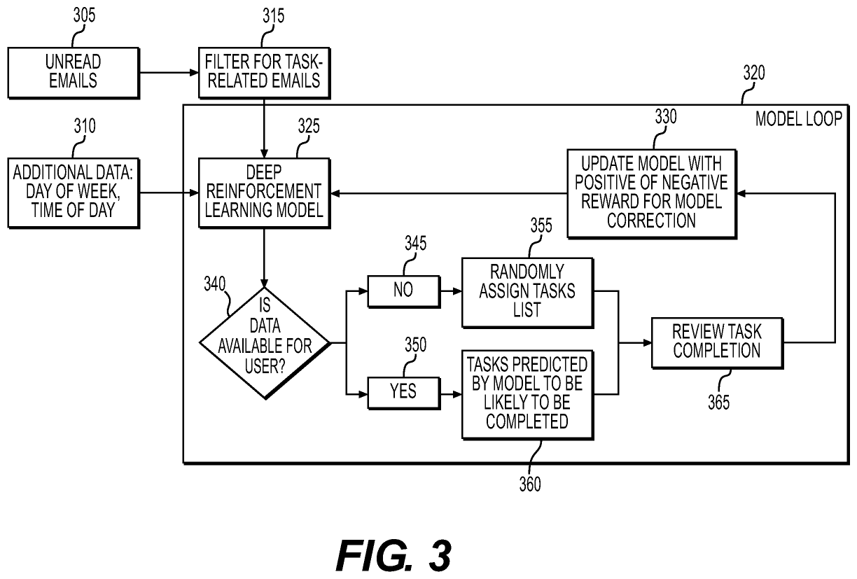

FIG. 3 is an example flow chart for scheduling tasks based on emails. At stage 305, a mail server 110 or SEG 120 can receive an unread email. The email can be associated with a user based on the recipient email address.

At stage 315, the SEG 120 or mail server 110 can filter for task-related emails. This can include parsing the email by applying an ML model 135 to determine intents and slots, or simply looking for keywords. A task can be identified based on recognition of a relationship between sender and recipient, reference to a backend system 140, reference to a project, or reference to a document, among other ways. If a task is identified, the task-related email can be processed for task scheduling. In one example, this can include sending a copy of that email to the management server 130 for task processing.

At stage 310, additional information can be sent to the management server 130 for use in processing the task. This can include information regarding the user's calendar.

The task scheduling process can operate as a loop for constantly upgrading an ML model 135 at stage 320. The stages that make up the loop of stage 320 are described as occurring at the management server 130, which can execute the task scheduling service in one example. However, the task scheduling service and loop of stage 320 can alternatively execute at a separate device, such as a ML training server or the user device 100. In general, the stages can execute either client-side or server-side, depending on the implementation.

At stage 325, the management server 130 can attempt to retrieve an ML model 135 that corresponds to the recipient user. To do this, the management server 130 can determine if any such data (e.g., a model or otherwise) is available for that user at stage 340. If not (at stage 345) then the management server 130 can resort to randomly assigning the task within an open time slot in the user's task list at stage 355. If data is available at stage 350 however, then the ML model 135 for that user can be selected and applied at stage 360. The existence of user data can indicate that the ML model 135 is likely to make a better selection than the otherwise random choice the management server 130 could make. The task is then scheduled, as previously outlined.

At stage 365, the management server 130 can review the task completion as part of improving model accuracy. To do this, the management server 130 can check either with the user device 100, the backend service 140, or both. For example, the management server 130 can communicate with the agent 108 of the user device 100. The agent 108 can monitor user activities at the user device 100 and report to the management server 130 regarding whether the task is complete. In one example, the management server 130 can check with the backend service 140 by making an API call and providing an identifier related to the task. For example, the API call can reference a trouble ticket number to see if the user has acted on the trouble ticket. Alternatively, if the task is an email response, the management server 130 can check with the email server to see if a reply email has been sent. The management server 130 can submit an identifier for the email or email chain and/or compare a sent time versus the received time of the email that the user is responding to.

In addition, the management server 130 can also retrieve information indicating when the task was completed. For example, the API response or agent communication can include a date and time that the task was completed. The date and time can be retrieved from the email server 110 or backend service 140, depending on what the task is. Alternatively or in addition, the agent 108 can track the user's completion of the task on the user device 100. This can include monitoring an application, such as the email application 104, for user activity related to the task. For example, the agent 108 can detect when the user replies to an email that is the subject of the task and report the reply to the management server 130.

In still another example, the agent 108 on the user device 100 can generate and display a task list 106. The task list 106 can display within the email application 104 in one example, allowing a user to interact with the element without navigating away from the application 104. For example, the task list 106 can be displayed as a series of cards or entries. The task itself can include one or more actionable buttons that, if selected, cause further action to be taken. In the example of authorizing an expenditure, the task can display an amount and description of the expenditure along with actionable buttons for approving or declining the expenditure. Based on the user's input with respect to the actionable buttons, the user device 100 can request an action from the management server 130. For example, if the user selects an actionable button to approve an expenditure, then the user device 100 can inform the management server 130 of this selection. The management server 130 can then utilize an API call to contact the relevant backend service 140 and provide an instruction to carry out the action indicated by the user. The management server 130 can also make note of the date and time that the task was completed and use that information in updating the ML model 135.

At stage 330, the loop of stage 320 can include updating the ML model 135 with a positive or negative reward. The positive or negative can be determined based on the date and time that the task was completed versus the date and time of the scheduled action. When the completion is proximate to the schedule, a positive reward can reinforce similar scheduling for similar future tasks. Conversely, when the completion is not proximate to the schedule, a negative disincentive can cause the training process to change the ML model 135 such that similar future tasks are scheduled at a different time.

The amount of time considered “proximate” can also be adjusted by an admin, in an example. This can allow an admin to influence the level of aggression involved in retraining the ML model 135. For example, a proximate time of 30 minutes may be more exacting than a proximate time of one hour, which can dictate whether a task response occurring at the 45-minute mark constitutes a positive reward or a negative disincentive. In turn, this can change the amount of tuning that the training algorithm attempts. In one example, the positive and negative rewards are allocated on a continuum according to how close the user's response was to the scheduled time. For example, a response occurring at the scheduled time could receive 100 pts, whereas a response 15 minutes later could receive 50 points, a response 30 minutes later could receive zero points, and a non-proximate response that is an hour later could receive −50 points. The training algorithm can use these inputs as it continuously retrains the user's ML model 135 in a way that maximizes points.

The retrained ML model 135 can then be supplied again to the management server 130, such that at a future stage 325 the management server retrieves the retrained ML model 135.

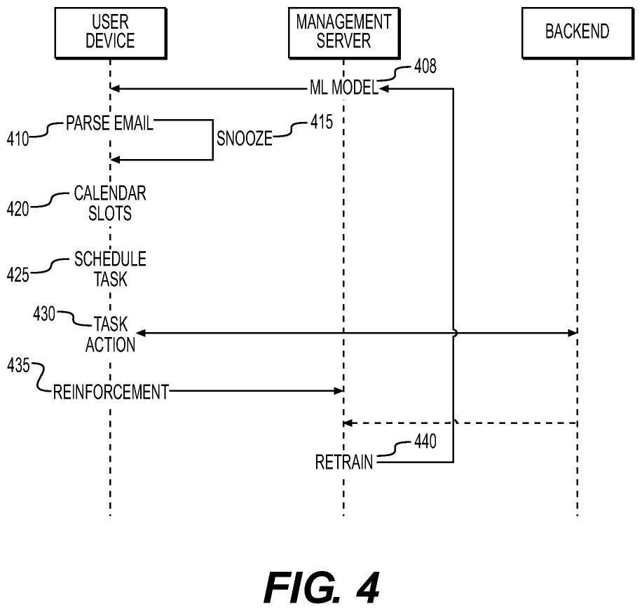

FIG. 4 provides a sequence diagram of an example method for scheduling actionable tasks from an email. However, unlike in FIG. 3, most of the stages of the task scheduling service are performed locally on the user device 100 in the example of FIG. 4.

At stage 408, the management server 130 can send a ML model 135 to the user device 100. The management server 130 can do so by communicating with the agent 108, which can download the ML model 135 onto the user device 100. The ML model 135 can include multiple ML models. For example, a first ML model can be pretrained to recognize tasks, such as by determining intents and slots, as previously discussed. A second ML model can be pretrained to determine when to schedule a task within a user's task list.

At stage 410, the agent 108 or ML model 135 can parse an unread email that is received in a user's inbox. The parsing can reveal that the email relates to an actionable task. For example, the email may require a response to a coworker, superior, or client. Alternatively, the email may reference a backend service 140 where tasks occur, such as time entry, billing, and project status updates.

The ML model 135 can be used to schedule the task within a time slot at stages 415, 420, and 425. For example, at stage 420, the agent 108 can determine open time slots from the user's calendar or other task list. The agent 108 can be given access to the task list as part of enrollment in the UEM system or the agent 108 can be responsible for generating the task list. The open time slots and task information from stage 410 can be used as inputs to the ML model 135 at stage 425. The ML model 135 can schedule the task for completion within an open time slot.

In one example, the agent 108 can also “snooze” the email at stage 415. This can include queuing the email itself or a reminder for sending to the user at the scheduled time determined in stage 425. This can cause the user to receive the email again or a reminder thereof at a time when the user is more likely to read the email and act on the task. To do so, the agent 108 can create a reminder or forward the email and set the email to send at the scheduled time determined in stage 425.

Scheduling the task at stage 425 can cause the task to appear in the task list 106. A task generated by the agent 108 (task scheduling service) can appear as a different color than other entries in the task list 106. This can help the user understand how the task appeared there. Additionally, the user may want to reschedule those tasks, which can also lead to the generation of information regarding ML reinforcement of stage 435.

At stage 430, the user can perform the action for completing the task. The action can differ between tasks, but can include responding to an email, submitting a status update, and checking in a file. The action at stage 430 can be tracked by the agent 108, which can then report the task completion and timing of the completion as part of reinforcement at stage 435. Alternatively, task completion can be reported by the backend system 140 to which the task pertains.

In one example, the user device 100 contacts the management server 130 as part of completing the task. For example, the management server 130 can identify a relevant backend system 140 and make corresponding API calls for completing the task in that system 140. The management server 130 can retrieve information from the backend system 140, such as information relating to actions that can be taken at the backend system 140 with respect to the identified intent-slot pairing. For example, the management server 130 can provide an intent-slot pairing that includes an intent to book a flight and a slot describing a day or time at which the flight should be booked. The management server 130 can then reach out to a backend server 140 such as CONCUR to retrieve any available actions for booking a flight on a particular day. The backend server 140 can respond with, for example, several available flight options and associated costs. This information can be passed to the user device 100 as part of completing the task, in an example.

At stage 435, the management server 130 or some other ML training platform can receive the task completion timing. The completion information can be used at stage 440 in comparison with the scheduled time as part of RL training of the ML model 135. As has been discussed, if the task is completed proximate to its scheduled time, the training algorithm can use a positive reinforcement that tends to cause the ML model 135 to continue scheduling similar tasks (e.g., same task type, project, or sender) during a similar time slot. Conversely, if the user did not complete the task proximate to the scheduled time, then negative reinforcement will tend to cause the ML model 135 to choose a different time for scheduling similar future tasks.

The retrained ML model 135 can then be used by the management server 130 at stage 408 for scheduling actionable tasks from additional unread email.

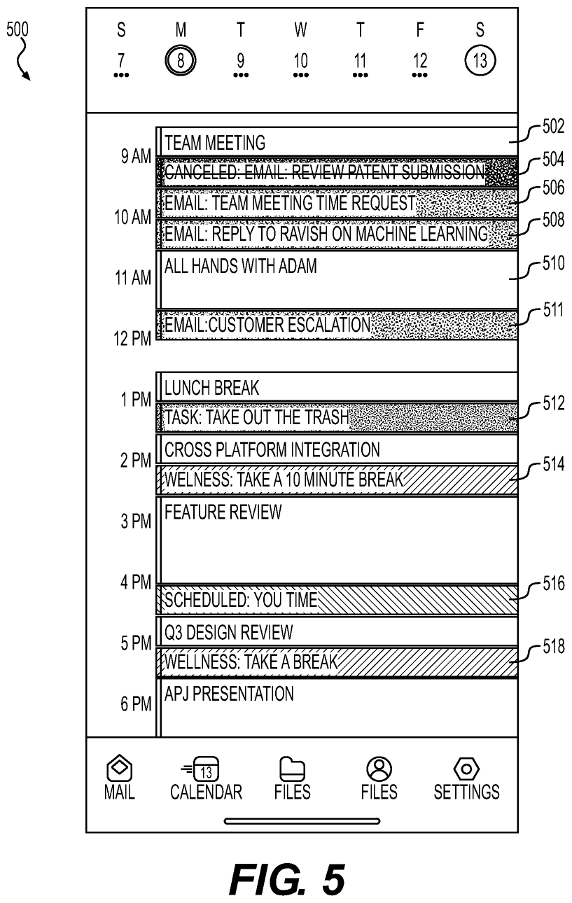

FIG. 5 provides an illustration of a GUI 500 on a user device 100 that displays scheduled tasks from actionable emails. In this example, the task list is part of a calendar application. Tasks 502-518 can indicate various scheduled activities. Of those, tasks 506, 508, and 511 can represent automatically scheduled tasks that require the user to make email responses. In this example, the automatically generated tasks 506, 508, and 511 are all shaded the same color, different from the other tasks 502, 504, 510.

In one example, the task scheduling service can also schedule wellness related tasks, such as tasks 516 or 518. The task scheduling service can detect that the task list 106 has become overly full of work tasks and attempt to ensure that the user takes some breaks that may be needed for maintaining productivity. In one example, the ML model 135 can detect when then user is likely to stop working on normal work tasks based on that user's past activities. The past activities can include past task completions reported from the agent 108 and relevant backend services 140. In this example, the ML model 135 decides that the user is likely to need a break at 4 PM to increase their productivity in the Q3 design review. Similarly, the ML model 135 can determine that another break will be needed after the design review and before the APJ presentation. Therefore, the agent 108 or management server 130 can schedule wellness tasks 516 and 518 accordingly.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for scheduling actionable emails, comprising:
identifying a task by parsing an unread email intended for a user;
locating at least one open time slot in a calendar associated with the user;
applying a machine learning model to the task and at least one open time slot, wherein the machine learning model is previously trained based on timing of prior tasks performed by the user;
scheduling the task at a first time within the time slot based on a result from the machine learning model, the task being displayed in a task list on a user device associated with the user; and
updating the machine learning model based on a second time in which the task is completed.

2. The method of claim 1, wherein the task list displays as part of a calendar on the user device, wherein the task appears as a different color than other events that are manually accepted by the user.

3. The method of claim 1, wherein the completion of the task is detected by at least:
querying a backend service associated with the task; and
receiving, from the backend service, information associated with completion of the task, wherein the information is used in updating the machine learning model.

4. The method of claim 1, wherein updating the machine learning model is based on positive and negative incentives corresponding to how close to a scheduled time that the user performs a respective task.

5. The method of claim 4,
wherein the second time is outside of a proximity threshold to the first time, and
wherein updating the machine learning model includes applying a negative incentive against using the time in scheduling future tasks of a same type as the task.

6. The method of claim 1, further comprising:
automatically sending a follow-up email to the user regarding the task, the follow-up email being sent at the time of the scheduled task.

7. The method of claim 1, wherein scheduling the task within the time slot includes moving a second task to another time based on the machine learning model predicting that the user is more likely to perform the task than the second task during the time slot.

8. A non-transitory, computer-readable medium containing instructions that, when executed by a hardware-based processor, performs stages for scheduling actionable emails, the stages comprising:
identifying a task by parsing an unread email intended for a user;
locating at least one open time slot in a calendar associated with the user;
applying a machine learning model to the task and at least one open time slot, wherein the machine learning model is previously trained based on timing of prior tasks performed by the user;
scheduling the task at a first time within the time slot based on a result from the machine learning model, the task being displayed in a task list on a user device associated with the user; and
updating the machine learning model based on a second time in which the task is completed.

9. The non-transitory, computer-readable medium of claim 8, wherein the task list displays as part of a calendar on the user device, wherein the task appears as a different color than other events that are manually accepted by the user.

10. The non-transitory, computer-readable medium of claim 8, wherein the completion of the task is detected by at least:
querying a backend service associated with the task; and
receiving, from the backend service, information associated with completion of the task,
wherein the information is used in updating the machine learning model.

11. The non-transitory, computer-readable medium of claim 8, wherein updating the machine learning model is based on positive and negative incentives corresponding to how close to a scheduled time that the user performs a respective task.

12. The non-transitory, computer-readable medium of claim 11,
wherein the second time is outside of a proximity threshold to the first time, and
wherein updating the machine learning model includes applying a negative incentive against using the time in scheduling future tasks of a same type as the task.

13. The non-transitory, computer-readable medium of claim 8, the stages further comprising:
automatically sending a follow-up email to the user regarding the task, the follow-up email being sent at the time of the scheduled task.

14. The non-transitory, computer-readable medium of claim 8, wherein scheduling the task within the time slot includes moving a second task to another time based on the machine learning model predicting that the user is more likely to perform the task than the second task during the time slot.

15. A system for scheduling actionable emails, comprising:
a memory storage including a non-transitory, computer-readable medium comprising instructions; and
a computing device including a hardware-based processor that executes the instructions to carry out stages comprising:
identifying a task by parsing an unread email intended for a user;
locating at least one open time slot in a calendar associated with the user;
applying a machine learning model to the task and at least one open time slot, wherein the machine learning model is previously trained based on timing of prior tasks performed by the user;
scheduling the task at a first time within the time slot based on a result from the machine learning model, the task being displayed in a task list on a user device associated with the user; and
updating the machine learning model based on a second time in which the task is completed.

16. The system of claim 15, wherein the task list displays as part of a calendar on the user device, wherein the task appears as a different color than other events that are manually accepted by the user.

17. The system of claim 15, wherein the completion of the task is detected by at least:
querying a backend service associated with the task; and
receiving, from the backend service, information associated with completion of the task,
wherein the information is used in updating the machine learning model.

18. The system of claim 15, wherein updating the machine learning model is based on positive and negative incentives corresponding to how close to a scheduled time that the user performs a respective task.

19. The system of claim 18,
wherein the second time is outside of a proximity threshold to the first time, and
wherein updating the machine learning model includes applying a negative incentive against using the time in scheduling future tasks of a same type as the task.

20. The system of claim 15, the stages further comprising:
automatically sending a follow-up email to the user regarding the task, the follow-up email being sent at the time of the scheduled task.
